(19) United States
(12) Patent Application Publication
(10) Pub. No.: US 2015/0039277 A1
(43) Pub. Date: Feb. 5, 2015

(54) APPARATUS, METHOD, AND COMPUTER-READABLE MEDIUM FOR PROVIDING A CONTROL INPUT SIGNAL FOR AN INDUSTRIAL PROCESS OR TECHNICAL SYSTEM

(71) Applicants: Alexandros Sopasakis, (US); Ximantis AB, Onsala (SE)

(72) Inventor: Alexandros Sopasakis, Onsala (SE)

(21) Appl. No.: 14/379,745

(22) PCT Filed: Feb. 21, 2013
(86) PCT No.: PCT/EP2013/053479

§ 371 Date: Aug. 19, 2014

Related U.S. Application Data
(60) Provisional application No. 61/601,048, filed on Feb. 21, 2012.

(30) Foreign Application Priority Data
Feb. 21, 2012 (SE) 1200105-3
Feb. 22, 2012 (SE) 1200144-2

(51) Int. Cl. G06F 17/50; G06N 7/00

(52) U.S. Cl. CPC G06F 17/5009; G06N 7/005
USPC 703/2

(57) ABSTRACT

An apparatus for providing a control input signal for an industrial process or technical system having one or more controllable elements is provided. A method and computer-readable medium is also provided.

### CROSS-REFERENCE TO RELATED APPLICATIONS

This application incorporates herein the entire contents of the U.S. provisional patent application 61/601,048 filed on 21 Feb. 2012, and the Swedish Patent Application No. 1200144-2 filed on 22 Feb. 2012, and the Swedish Patent Application No. 1200105-3 filed on 21 Feb. 2012 by reference.

### TECHNICAL FIELD

The present invention relates to an apparatus, method and computer-readable medium for providing a control input signal for an industrial process or technical system. More particularly, the control input signal comprises information about predicted location for an object, which predicted location is calculated based on a Monte Carlo Simulation.

### BACKGROUND

Stimulated by the exponential growth in CPU power computationally intensive models and applications have thrived in recent decades. Among them lattice models through Cellular Automaton (CA) and/or Monte Carlo methods have proliferated significantly and are increasingly used to describe and understand a wide variety of complex physical and biological systems. CA for instance has been used in modeling gas phenomena, urban development, immunological processes, and crystallization. The best known application for CA is modeling living systems.

Monte Carlo methods are used for a variety of scientific applications. Systems can be simulated for up to 10¹⁰ mesh points for some specialized computer architectures. In many cases however critical slowing down occurs when the dynamics reach equilibration thus even Monte Carlo approaches become computationally expensive.

Among the many choices for numerically updating stochastic dynamics the Kinetic Monte Carlo (KMC) algorithm or n-fold way is prominent since there is no slowing-down effect at the process nears equilibration. In that respect every move performed by the KMC algorithm results in a success. Under the KMC update objects perform moves at every time iteration regardless of whether the system is near equilibration or not. As a result KMC is a favorite in the literature since it avoids excessive computational overhead due to this critical slowing down phenomenon which can be detrimental for typical Monte Carlo methods.

Lattice models in conjunction with Monte Carlo methods are often used as a way of modeling systems involving many interacting objects under the influence of noise. Such approaches have been followed in many fields although they are particularly responsible for significant innovation in space and oil exploration. Similarly, molecular dynamics modeling through lattice gas CA or lattice Boltzmann methods are responsible for producing a better understanding for a number of fundamental scientific problems in the physics of fluids.

A lattice based model describes an object system by introducing a spatial discrete lattice consisting of predetermined number of cells within which the object interactions and dynamics will evolve. One common approach is to built a Markov Chain which evolves the dynamics responsible for constructing the solution of the system. The stochastic dynamics applied depend on the physical properties describing the microscopic interactions for the system. As a result, Metropolis, Arrhenius, Glauber, Kawasaki and other rates are carefully considered depending on the knowledge of the microscopic behavior of the system. The applications of such methodologies range from granular material, traffic flow, ecology, lattice Boltzmann and lattice gas, surface growth just to name a few.

Current kinetic Monte Carlo simulations commonly utilize lattice based approach, in which each object in a system may move to a limited number of discrete locations defined by the lattice based approach.

However, it has been found that the lattice based approach is associated with a number of drawbacks. Hence, an improved apparatus, method or computer-readable medium for providing a control input signal comprising information about a predicted location for an industrial process or technical system would be advantageous.

### SUMMARY

Accordingly, the present invention preferably seeks to mitigate, alleviate or eliminate the found deficiencies in the art and solves these found problems by providing an apparatus, method and computer-readable medium according to the appended patent claims.

In an aspect an apparatus for providing a control input signal for an industrial process or technical system having one or more controllable elements is provided. The apparatus comprises a unit adapted to access a dataset comprising data for a number of objects being divided into a first set of objects and a second set of objects, wherein the objects of the first set of objects are located in a reservoir, and the objects of the second set of objects are being spatially distributed in a defined geometrical region at a fixed point in time, wherein said geometrical region defines a continuous space including the locations of the second set of objects and locations of empty space to which the first set of objects and the second set of objects can move. The apparatus further comprises a unit adapted to index the number of objects, resulting in indexed data. Moreover, the apparatus comprises a unit 13 adapted to calculate at least one rate for each object of the number of objects, said at least one rate defining a region within the continuous space, said region comprising at least one location within the continuous space, wherein each at least one location is associated with a coordinate of the at least one rate, wherein at least a first rate of the at least one calculated rate for each object is calculated with a weight corresponding to the amount of empty space available between the second set of objects within the continuous space, wherein the number of rates calculated for each object is added to form a total rate for each object, and wherein the total rates for the number of objects form a set of calculated total rates. Furthermore, the apparatus comprises a unit adapted to execute a Monte Carlo simulation based on the indexed data and the set of calculated rates and to calculate a predicted location for an object of the number of objects at a given end time, wherein the predicted location is either within the continuous space or within the reservoir, and wherein the predicted location is stored on a memory operatively coupled to the apparatus. Moreover, the apparatus comprises a unit adapted to provide the predicted location for at least one object in a control input signal to said industrial process or technical system.

In another aspect a method for providing a control input signal for an industrial process or technical system having one or more controllable elements is provided. The method comprises accessing a dataset comprising data for a number of objects being divided into a first set of objects and a second set of objects, wherein the first set of objects are located in a reservoir, and the second set of objects are being spatially distributed in a defined geometrical region at a fixed point in time, wherein said geometrical region defines a continuous space including the locations of the second set of objects and locations of empty space to which the first set of objects and the second set of objects can move. The method further comprises indexing the number of objects, resulting in indexed data. The method further comprises calculating at least one rate for each object of the number of objects, said at least one rate defining a region within the continuous space, said region comprising at least one location within the continuous space, wherein each at least one location is associated with a coordinate of the at least one rate, wherein at least a first rate of the at least one calculated rate for each object is calculated with a weight corresponding to the amount of empty space available between the second set of objects within the continuous space, wherein the number of rates calculated for each object is added to form a total rate for each object, and wherein the total rates for the number of objects form a set of calculated total rates. Furthermore, the method comprises executing a Monte Carlo simulation based on the indexed data and the set of calculated total rates and to calculate a predicted location for an object of the number of objects at a given end time, wherein the predicted location is either within the continuous space or within the reservoir. Moreover, the method comprises providing the predicted location for at least one object in a control input signal to said industrial process or technical system.

In yet another aspect a computer-readable medium is provided. The computer-readable medium comprises code segments arranged, when run by an apparatus having computer-processing properties, for performing all of the method steps in any one of the embodiments disclosed herein.

In another aspect a technical system comprising one or more controllable elements is provided. At least one of the controllable elements is configured to receive the control input signal from the apparatus according to any one of the embodiments disclosed herein.

In another aspect a system comprising the technical system and apparatus according to any one of the embodiments disclosed herein is provided.

An advantage of the present invention is that it removes the significant errors caused by the commonly known lattice based approach, and in particular in situations where the objects processed do not have a non-negligible size.

A further advantage of the present invention is that the average density of the objects within the geometrical region at any given time is more realistic than the average densities resulting from using the lattice based approach.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1 shows an apparatus according to an embodiment;

FIG. 2 illustrates a schematic of a number of objects (P1, P2, P3, Pk) located at different locations in a continuous space Λ for one-dimensional example and the empty spaces between the number of objects, according to an embodiment;

FIG. 3 shows an adsorption at x* for one-dimensional example, according to an embodiment;

FIG. 4 schematically shows a unit for calculating a rate for an object according to an embodiment;

FIG. 5 schematically shows a unit for calculating a rate for an object according to an embodiment;

FIG. 6 illustrates a number of calculated total rates for each object P1, P2, P3, P4, P5 and the entities A1, A2, A3 associated with each calculated total rate for a one-dimensional continuous space, according to an embodiment;

FIG. 7 illustrates a number of calculated total rates for each object P1, P2, P3, P4, P5 and the entities A1, A2, A3, A4 associated with each calculated total rate for a two-dimensional continuous space, according to an embodiment;

FIG. 8 schematically shows a unit for executing a kinetic Monte Carlo simulation according to an embodiment;

FIG. 9 shows a flow chart of a method according to an embodiment;

FIG. 10 illustrates a computer-readable medium according to an embodiment;

FIG. 11 shows a comparison between the commonly known lattice based approach and the lattice free approach according to an embodiment;

FIG. 12 illustrates a comparison of the total average density for βJ₀=3 versus domain size for the classic LB dynamics versus the LF dynamics according to an embodiment and the Palasti conjecture predicted solution;

FIG. 13 shows a technical system according to an embodiment; and

FIG. 14 shows a system comprising a technical system and an apparatus according to an embodiment.

### DESCRIPTION OF EMBODIMENTS

The present invention according to some embodiments is based on a construction of a lattice-free (LF) stochastic process. The underlying stochastic dynamics are stripped of their dependence on the usual lattice-based (LB) environment. Interacting objects therefore will be free to land and interact at locations prescribed by the dynamics from stochastic rates which are distance based instead of cell based. In some embodiment the stochastic process is equipped with an Arrhenius spin-flip (non-conservative), hard sphere, exclusion potential and examine/compare the object behavior at equilibrium as well as on the transition path to equilibrium. Other potentials can also be considered as well since the findings of this work are not tied to the particular form of the interaction potential used. A commonly known Monte Carlo simulation, such as a kinetic Monte Carlo simulation, may be used in order to practically implement this LF stochastic process.

The LF dynamics used in the present invention is derived such as to overcome shortcomings in solutions produced by LB dynamics under certain regimes where object sizes can influence or interfere with their interactions. Under such regimes LB dynamics and corresponding LB models can produce erroneous results with non-physical solutions. This phenomenon occurs for all interaction potentials. The differences in solutions however are most pronounced for model parameters promoting high object densities. Furthermore, it is shown that convergence will not fix this discrepancy. In other words, as the lattice size increases the solutions from LB dynamics will not converge to that of the LF dynamics. Clearly the reason for the difference in solutions between LB and LF dynamics simply results from the fact that a lattice, with predefined cells for objects to land in, offers a more efficient use of space. As a result the corresponding density of those objects can be much higher in the case of LB models. Many natural processes involve object moving in continuum space and not in preset distances/cells as is the case for LB environments. Thus in several modeling situations such a LB methodology, although easier to implement, will produce wrong solutions.

An idea of the present invention is to provide a control input signal to a technical process or system, wherein the control input signal comprises information about a predicted location of an object, at a given end time. The predicted location is based on a Monte Carlo simulation, such as a kinetic Monte Carlo simulation, executed until the given end time has been met. The object is an object comprised in a number of objects. Each object of the number of objects is at each instance either located within a geometrical region, also referred to as a domain, or within in a reservoir which defines a location outside the geometrical region. The geometrical region defines a continuous space including the locations of the objects currently located within the continuous space and locations of empty space to which the number of objects can move.

The continuous space differs from the domain used in lattice based (LB) calculations. In particular, the continuous space includes the locations of the objects already located in the continuous space, and locations of empty space to which any of the objects of the number of objects can move. Hence, the continuous space relates to a lattice free environment.

In contrast, the domain for a lattice based approach only allows objects to move to discrete and preset locations, also referred to as cells, within the domain. Objects are not allowed for instance to relocate to positions between those preset location cells, since each object would then cover a space in two or more cells. Hence, there are only few locations available for an object to move to using the commonly known lattice based approach.

Accordingly, the move of an object within or to the continuous space is not limited to any cells, and in this regard the move is distance based instead of cell based. In other words, each object may move to a location within the continuous space without being limited by the cells of a lattice.

Accordingly, compared to a lattice based approach, an object based on the teachings of the present invention may move to any location within the continuous space as long as that location is not already occupied by another object. Hence, in accordance with the embodiments of the present invention, the actual location of an object could, in view of a lattice based approach, be a location between two or more cells. As the object has a certain size, once positioned at such a location, in view of the lattice based approach, different parts of the object would in fact be located in several cells at any instance.

A problem solved by the embodiments disclosed herein may be considered as how to accurately and realistically predict a location for an object in a system of objects, wherein the object size it taken into consideration.

A further problem solved the embodiments provided herein may be considered as how to predict the location of an object of a system of objects which are completely free to move to any location within a geometrical region, and thus not limited to move only into discrete cells.

Since the objects using the lattice based approach are not allowed to move freely as in real life, but instead only be allowed to move from cell to cell, the predicted resulting average density will be unrealistically high.

In very general terms one could say that the present invention relates to a lattice-free hard sphere exclusion stochastic process, which will be apparent from the embodiments incorporated herein.

It should be appreciated that the dynamics involved behave differently than those in the lattice-based environment. This difference becomes increasingly larger with respect to object densities/temperatures as will be further elucidated below. Furthermore, the well-known packing problem in mathematics and its solution relating to the Palasti conjecture has been showed to confirm the results produces by the lattice-free dynamics used in the embodiments of the present invention.

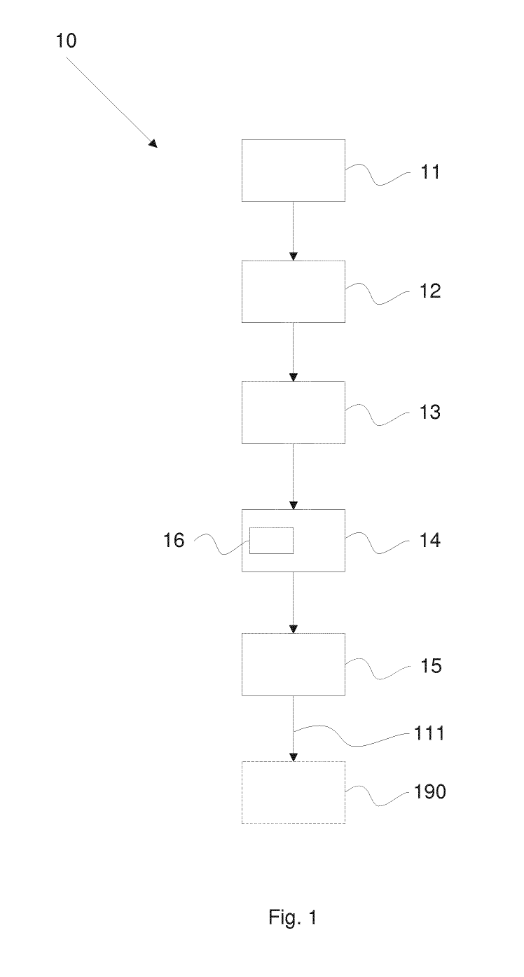

In an embodiment, according to FIG. 1, an apparatus 10 for providing a control input signal 111 for an industrial process or technical system 190 having one or more controllable elements 131 is provided. The apparatus comprises a unit 11 adapted to access a dataset comprising data for a number of objects P1, P2, P3, P4, P5 being divided into a first set of objects and a second set of objects. The objects of the first set of objects are located in a reservoir. The objects of the second set of objects are being spatially distributed in a defined geometrical region at a fixed point in time. The geometrical region defines a continuous space including the locations of the second set of objects and locations of empty space to which the first set of objects and the second set of objects can move.

The apparatus further comprises a unit 12 adapted to index the number of objects P1, P2, P3, P4, P5, resulting in indexed data.

Moreover, the apparatus comprises a unit 13 adapted to calculate at least one rate R, c for each object P1, P2, P3, P4, P5 of the number of objects. Each at least one rate defines a region within the continuous space, said region comprising at least one location within the continuous space, wherein each at least one location is associated with a coordinate of the at least one rate, Λ first rate of the at least one calculated rate is calculated with a weight corresponding to the amount of empty space available between the second set of objects P1, P2, P3, P4, P5 within the continuous space. The number of rates calculated for each object is added to form a total rate for each object. The total rates for the number of objects form a set of calculated total rates.

The apparatus further comprises a unit 14 adapted to execute a Monte Carlo simulation based on the indexed data and the set of calculated rates and to calculate a predicted location for an object of the number of objects at a given end time. The predicted location is either within the continuous space or within the reservoir, and wherein the predicted location is stored on a memory 16 operatively coupled to the apparatus 10.

Furthermore, the apparatus comprises a unit 15 adapted to provide the predicted location for at least one object P1, P2, P3, P4, P5 in a control input signal 111 to said industrial process or technical system 190.

In an embodiment, the Monte Carlo simulation is a kinetic Monte Carlo simulation.

Each of the units 11, 12, 13, 14, 15 of the apparatus may comprise a processor optionally connected to a memory 16.

In an embodiment, each of the units of the apparatus may be combined in a single unit comprising a processor and a memory 16.

As may be observed from the first embodiment at least one rate of the rates calculated for each object, takes into consideration the available empty spaces within the continuous space. In the event that there is no available empty space in the continuous space at a certain time throughout the simulation, i.e. iteration step, the first rate for each object will not he calculated for that iteration. Accordingly, the total rate for each object will in such case be related to the other rates calculated for that object, which other rates does not take into consideration the empty space available in the continuous space. Such other rates may relate to desorption or reaction rates as will be further elucidated below.

General Framework

To facilitate the understanding of the first embodiment, the general framework for the lattice free continuous space is described below.

We let Λ= [symbol] ^{d} to define the continuous space where [symbol] ^{d}=[0,1)^{d} is a d-dimensional torus and d denotes the spatial dimension. For contrast it should be appreciated that for a typical two-dimensional LB stochastic process the corresponding lattice L consists of a predetermined number of microscopic cells all of which have the exact same dimensions and each of which could accommodate a single object.

For now it is assumed that all objects occupy the same volume Bᵢ=Bᵣ(\vec{x}ᵢ) with radius r around their centers \vec{x}ᵢ ∈ Λ and that physically it will not be possible for two objects to occupy the same space. This will be implemented below using an exclusion principle.

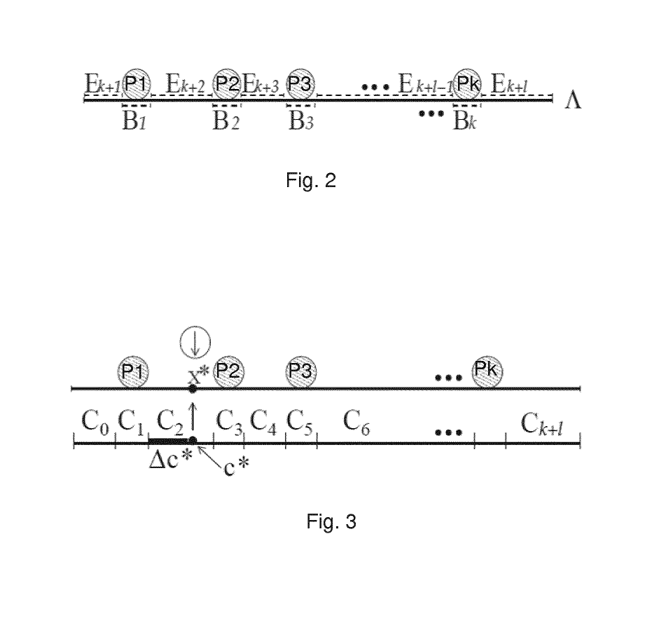

FIG. 2 illustrates a schematic of a number of objects (P1, P2, P3, Pk) located at different locations in a continuous space Λ for one-dimensional example. The Eᵢ's denotes the set of available empty space in the continuous space and vary in size. Bᵢ's denote the set of already occupied space in the continuous space defined by each object already located in the continuous space and the size of the occupied space is the same as that of the object.

The continuous space is comprised of a number of disjoint sets Λ=P∪P^{C}. Here P=∪B(\vec{x}ᵢ) for i=1, . . . , k and P^{C}=∪Eᵢ for k+1≦i≦k+l where Eᵢ denotes all the disjoint available space in Λ. Note that the size of the Eᵢ's can differ since each Eᵢ denotes the empty space between objects with centers at xᵢ and xᵢ₊₁, i.e. |Ei|=|xᵢ₊₁−xᵢ|−2r. In contrast the size of the Bᵢ's is the same. In one-dimension for instance each Bᵢ=Bᵣ(\vec{x}ᵢ) corresponds to a line segment occupied by an object, as may be observed in FIG. 2. For simplicity, here the objects are defined to have the same size. However, it is equally possible within the scope of the invention to consider objects with varying sizes, by keeping track of their respective radius.

For a two-dimensional continuous space the set of occupied space Bᵢ's and set of available empty space Eᵢ's both represent areas. Note therefore that the continuous space can always be represented as a set of a finite number of such empty and filled sets,

Λ=P∪P^{C}=B₁∪B₂∪ . . . ∪Bₖ∪Eₖ₊₁∪ . . . ∪Eₖ₊ₗ

even as those sets will be changing while the objects move and occupy different locations over time.

The degrees of freedom (the microscopic order parameter) is given by a spin-like variable σ(i) for 1≦i≦k+l for each set Bᵢ or Eᵢ ∈ Λ.

Although the embodiments of the present invention deal with discrete spin variables, generalizations to the continuous case (Heisenberg model) may also be carried out without any major changes.

We start by defining anicroscopic stochastic process {σ}ₜ and define each σ(i) to occupy a volume equivalent to the object volume it is supposed to represent. Specifically

$$σ ( i ) = \{ \begin{matrix}1 , & if there exist a particle at i , \\ 0 , & if there is no particle at i , \end{matrix}$$

where 1≦i≦k+l.

The configuration of spins on the continuous space is denoted by σ={σ(i)|1≦i≦k+l}. A spin configuration σ can attain the values of 0 for each empty space or 1 for each occupied space in the continuous space.

The interactions between spins are defined by the microscopic Hamiltonian,

$$H ( σ ) = - \frac{1}{2} {\sum }_{i = 1}^{k + l} {\sum }_{j = 1}^{k + l} J ( i - 1 ) σ ( i ) σ ( j ) + {\sum }_{i = 1}^{k + l} {h}_{i} σ ( i ) , \qquad ( 2.1 )$$

where hᵢ=h(\vec{x}ᵢ) denotes the external field at \vec{x}ᵢ. We note that this Hamiltonian is not used directly towards the construction of the Markov chain however. Instead, for that purpose, we make use of the local, hard sphere type, interaction potential J

$$J ( i - j ) = \frac{1}{{( 2 L + 1 )}^{d}} V ( \frac{1}{2 L + 1} \vert {\vec{x}}_{i} - {\vec{x}}_{j} \vert ) , 1 \leq i \leq k + l , \qquad ( 2.2 )$$

where we let V: [symbol] → [symbol] with V(s)=V(−s) and V(s)=0 if |s|≧1, wherein s is a variable which take all possible values of the real numbers of [symbol] . For simplicity, V(s)=J₀ for |s|<1. Here, V is a potential function, d is the dimension of the continuous space, |\vec{x}ᵢ−\vec{x}ⱼ| is the distance between two locations i and j, k defines the number of objects, and l defines number of available empty spaces in the continuous space. Uniform potentials are assumed whereby J₀ is a constant. The constant J₀ is calibrated from real data and it related to particular properties of the objects being processed. Hence, J₀ relates to how quickly the objects move in real life. The interaction radius for these potentials is denoted by L in equation 2.2. It should be appreciated that notation L should not be confused with the notation L for the lattice mentioned earlier. Note that due to the construction of V the potential in equation 2.2 and corresponding Hamiltonian equation 2.1 involves a summation which provides a finite result even in the case of N,L→∞. The canonical equilibrium state for the stochastic process {σᵢ}_{i≧0} is given by the Gibbs measure, also referred to as the Gibbs probability,

$${μ}_{β} ( σ ) = \frac{1}{{Z}_{β}} {e}^{- β H ( σ )} P ( d σ ) , \qquad ( 2.3 )$$

where b=1/kT is the inverse temperature and k is the Boltzmann constant. Here Z_{β} is the normalizing partition function and P(dσ)=Π_{\vec{x}∈Λπ}(dσ(\vec{x})) the a priori Bernoulli product measure. Typical choice for ρ in Ising systems would be ρ(0)=ρ(1)=1/2.

General Description of Rates

Depending on how objects interact it is possible to equip the objects with rates associated with different dynamics. In Ising systems for instance Metropolis dynamics are applied with rate

c(i,σ)=Ψ(−βΔ_{\vec{x}}_{ᵢ}H(σ)),

where Δₓ_{ᵢ}H(σ)=H(σ^{\vec{x}}^{ᵢ})−H(σ)

with Ψ a continuous function satisfying Ψ(r)=Ψ(−r)e^{-r}, r ∈ R. Other common choices for Ψ can be Glauber Ψ(r)=(1+e^{r})⁻¹, Kawasaki, or Barker. The type of dynamics chosen is of great importance for the proper description of the underlying physical process. In Metropolis dynamics for instance the choice to perform a spin-flip depends on the energy difference between the initial and final states of the process. On the other hand in Arrhenius dynamics the activation energy of spin-flip is defined as the energy barrier a species has to overcome in jumping from one phase to another. These rates are derived from transition state theory or molecular dynamics calculations.

In an embodiment, one or more of the first rates is a spin-flip rate related to adsorption.

Spin-flip dynamics such as that defined by Arrhenius is known in the art. Such dynamics are usually associated with desorption or adsorption of objects from and to a surface. For traffic flow, for instance, such non-Hamiltonian dynamics are responsible for adding or removing vehicles from the highway at select locations while in micro-magnetics they are responsible for changing the overall magnetization of the surface according to a prescribed temperature.

The rate by which spin-flip dynamics evolve objects in a LF domain is given by

$$c ( i , σ ) = \{ \begin{matrix}{c}_{d} exp ( - β U ( i , σ ) ) , & if σ ( i ) = 1 , \\ {c}_{a} w ( i ) & if σ ( i ) = 0 ,\end{matrix} \qquad ( 3.1 )$$

for 1≦i≦k+l. Here w(i) is a weight function related to the empty space still available for object adsorption at location i in the continuous space. The exact details for w(i) will be provided below in (4.1). Here cₐ and c_{d} denote adsorption and desorption constants respectively and involve the inverse of the characteristic time of the stochastic process.

Accordingly, the first rate calculated for each object in an embodiment relates to the absorption rate cₐw(i) which is dependent on the empty space within the continuous space. A second rate of the calculated rates for each object may relate to the desorption rate c_{d}exp(−βU(i,σ)) which is not based on the empty spaces available in the continuous space.

Usually cₐ and c_{d} are calibrated from experimental parameters such as object velocities or reaction times. The potential function in equation 3.1 is given by U(i,σ)=Σᵢ₌₁^{k+l}J(i−j)σ(j)−hᵢ with J from equation 2.2. Based on the equation 3.1 if there is already a object located at i then we have σ(i)=1 and therefore it is not possible to adsorb a new object at that location since the rate c(i,σ) in equation 3.1 only allows desorption from such a location. Thus an exclusion principle is enforced.

The stochastic process {σᵢ}_{t≧0} is a continuous time jump Markov process on L^{∞}(Λ; [symbol] ) which evolves with the rule

$$\frac{d}{dt} 𝔼f ( σ ) = 𝔼 Lf ( σ ) .$$

Here [symbol] denotes the expected value with respect to the equilibrium measure μ_{β} from equation 2.3, ƒ ∈ L^{∞}(Λ; [symbol] ) is a test function and [symbol] denotes the generator for this stochastic process

$$Lf ( σ ) = {\sum }_{i = 1}^{k + 1} c ( i , σ ) [ f ( {σ}^{{\vec{x}}_{i}^{*}} ) - f ( σ ) ]$$

where \vec{x}*ᵢ denotes the configuration after the spin has changed (flipped) at \vec{x}ᵢ Detailed balance c(i,σ)exp(−H(σ))=c(i,σ^{\vec{x}}^{ᵢ}*)exp(−H(σ^{\vec{x}}^{ᵢ}*) ensures that the invariant measure for this process is the Gibbs measure prescribed by equation 2.3.

In an embodiment, a second rate of the at least one rate calculated for each object is a spin flip rate related to desorption c_{d}exp(−βU(i,σ)).

When using a first rate related to adsorption this takes into account the possibility of an object to move to a location within the continuous space using adsorption.

When using a second rate related to desorption this takes into account the possibility of an object to move to a location within reservoir using desorption.

The first rate or second rate can in these cases be calculated based on equation 3.1. The first rate when related to adsorption depend on the amount of available empty space in the continuous space. In classic LB KMC algorithms the adsorption rates are calculated for each unoccupied lattice cell with weight w(i)=1.

In contrast, the first rate according to some embodiments is calculated by first identifying all the available empty space, Eᵢ's, within the domain. Then, the adsorption rate is calculated with a weight corresponding to the amount of available empty space found. In the one-dimensional case for instance

$$w ( i ) = \{ \begin{matrix}\vert {E}_{i} \vert - 2 r , & if \vert {E}_{i} \vert > 2 r , \\ 0 , & otherwise . \end{matrix} \qquad ( 4.1 )$$

This implies that if the size of the empty space between two adjacent object locations is not large enough then the corresponding adsorption rate is 0 and no object has a chance of landing there (exclusion principle). This is enforced through the stochastic rate c(i,σ) in equation 3.1.

The Predicted Location

The predicted location relates to the location at which an object of the number of object at a given time will be located. The predicted location may be calculated through the invariant measure μ_{β} from equation 2.3 above, where μ_{β} is a so called Gaussian distribution, and the probabilities associated with the calculated rates follow this Gaussian distribution. Hence, the probability for each calculated rate may be calculated based on μ_{β}.

It should be appreciated that for Arrhenius dynamics a spin is flipped as long as the rate (energy barrier) has been overcome. Sampling for instance from μ_{β} under the detailed balance condition a random rate c* is chosen as follows 0≦c*≦Σᵢ₌₁^{k+l}c(i,σ). Assume for instance

$${\sum }_{i = 1}^{m + 1} c ( i , σ ) > {c}^{*} \geq {\sum }_{i = 1}^{m} c ( i , σ ) ,$$

for some 0≦m<k+l. Then in classic LB methods an object would adsorb at lattice cell m, while in the embodiments of the present invention m refers to the m-th location being occupied by an object. As mentioned above the LF dynamics of the present invention do not involve such cell boundaries. Instead, any object may adsorb to a location \vec{x}* corresponding to the exact rate c*, as may be observed in FIG. 3

FIG. 3 shows an adsorption at x* for one-dimensional example. The rates cᵢ for each location in this LF continuous space are calculated from equation 3.1 depending on whether the location in the continuous space is occupied by a object or not. The adsorption location x* is then obtained from equation 4.2.

In the one-dimensional case for instance

x*=Δc*/cₐ+2r, (4.2)

where Δc*=c*−Σᵢ₌₁^{m}c(i,σ). Similar calculations can be performed in higher dimensions as well. A general pseudo-code for the LF approach suggested in the present invention may be found below.

In an embodiment, one or more of the first rates is a deposition rate, which is calculated based on the same equations as for adsorption, but with different constants. The deposition rate may e.g. be used for applications related to epitaxial processes.

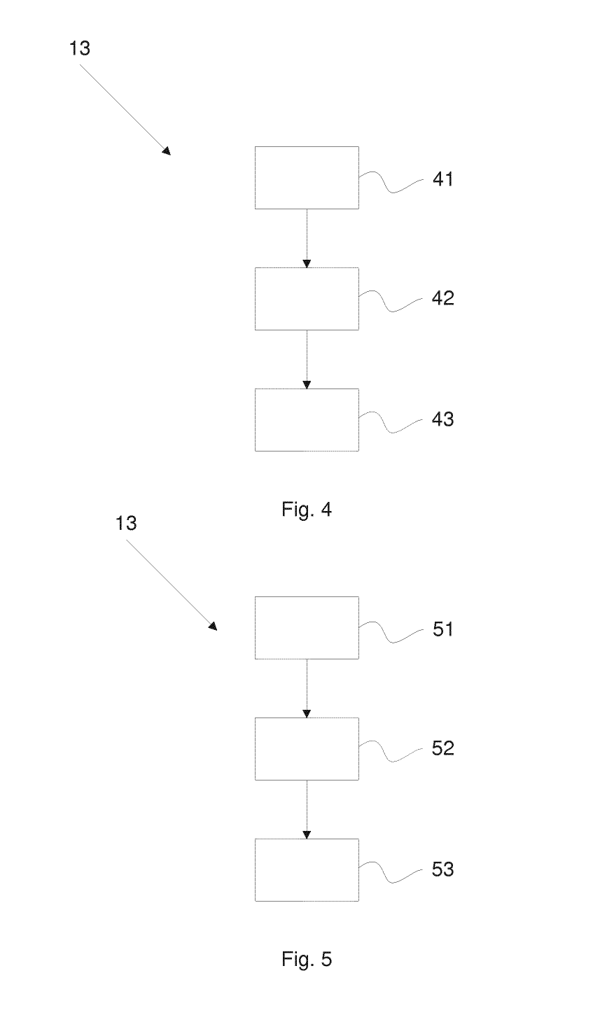

In an embodiment, according to FIG. 4, wherein one or more of the first rates is related to an adsorption rate or deposition rate, the 13 adapted to calculate the first rate for each object is adapted to identify 41 an empty space (E) within the continuous space between two or more objects of the number of objects. The unit 13 is further adapted to measure 42 the size of each identified empty space, and categorize each identified empty space which is large enough to accommodate an object in a first set of empty space. Furthermore, the unit 13 is based on the identified first set of empty space adapted to calculate 43 the first rate for an object in the first set of objects allowing for that object of the first set of objects to land at each empty space of the first set of empty space.

In an embodiment, one or more of the first rates is a spin-exchange rate related to diffusion.

When one or more of the first rates is a spin-exchange rate related to diffusion, the unit 13 according to an embodiment in view of FIG. 5 is adapted to calculate the first rate for each object is configured to identify 51 an empty space Eᵢ within the continuous space between an object of the second set of objects, for which object the first rate is to be calculated, and at least one other object in the second set of objects. The unit 13 is further configured to calculate 52 an interaction potential for each object of the second set of objects to move to the empty space identified for that object is calculated. The interaction potential defines functions related to how the object is allowed to interact with the other objects in the data. The unit 13 is based on the interaction potential further configured to calculate 53 the first rate for each object in the second set of objects, wherein each first rate allows for an object to land at the empty space identified for that object.

According to an embodiment, the interaction potential (J) is calculated by the equation 2.2 above.

According to an embodiment, each calculated rate is a deterministic rate being defined by functions which include a set of variables and parameters, wherein each variable is an unknown which may take any value within a predefined range.

In an embodiment a second rate of the at least one rate for each object is a contact rate. Contact rates may be used in application related to epidemiology.

In this embodiment, a Susceptible, Infected, and Recovered SIR model relating to epidemics with removal for plant spread of disease based on stochastic dynamics is provided. A contact process with a generator is applied, wherein the generator is responsible for producing the evolution of the stochastic process a. Although it is not related directly to the microscopic information, it may be relevant for averaged, e.g. macroscopic, information. The generator Lg(σ) may be calculated by:

$$Lg ( σ ) = {Σ}_{x ∈ L} c ( x , σ ) [ g ( {σ}^{x} ) - g ( σ ) ] ,$$

g ∈ L^{∞}(Σ;R) where Σ={0,1 [symbol] . The microscopic rate for the contact process is given by,

c(x,σ)=(1−σ(x))B[σ(x)]+σ(x)R

where R is the rate of recovery and

$$B [ σ ( x ) ] = {J}_{1} + {J}_{2} {Σ}_{y \neq x} f ( x - y ) σ ( y )$$

denotes the infectivity, and f is a given contact kernel. For this embodiment, the important formula is the microscopic contact rate c(x,σ) for the contact process. For example, it could be envisioned that there is an infection in some locations within the continuous space. The microscopic rate gives an indication of how the infection, which is located at a location within the continuous space, infects another location at an empty space near its current location. The microscopic rate for the infection to spread further is defined by B[σ(x)]. Moreover, the microscopic rate also provides information on how the infected region may recover with rate R. That rate R=R(t) is a constant but could for some applications also depend on time. Accordingly, it should be appreciated that the available empty space within the continuous space for this embodiment relates to non-infected regions. Hence, in order to determine how the infectivity spreads or does not spread over time these empty spaces need to be identified in order to identify the non-infected regions from which the contact rate c(x,σ) is calculated.

In an embodiment, a second rate of the at least one rate for each object is a reaction rate, which may relate to enzymes. It should be appreciated that calculation of a such a reaction rate is not based on empty spaces available in the continuous space.

In an embodiment, the interaction potential defines interactions being related to: anisotropy; local interactions of each object with other objects on a look-ahead or symmetric basis; long-range interactions; or external interactions.

Local interactions are the interactions defined above in view of spin-flip, adsorption, desorption, contact and reaction rates. Long-range interactions differs from local interactions. Typically such long range interactions take into account interactions with all objects in the continuous space and not just the one that are local to the object for which the total rate is calculated for.

Long-range interactions may be calculated using the equation 2.2, with the difference in that the potential function V is now unlimited. In other words V(s)=J₀ for all possible values of s. The equation 2.2 is then used to calculate the long-range interactions for each object in the continuous space. Then equation 2.2. is used in the potential function U(i,σ)=Σⱼ₌₁^{k+l}J(i−j)σ(j).

External interactions are user defined and in real applications it signifies effects such as sudden rain or accident or other external events which may have some impact in our traffic simulation on the roadway for instance. In U(i,σ)=Σᵢ₌₁^{k+l}J(i−j)σ(j)−hᵢ as given above, hᵢ relates to external interactions. Accordingly, U(i,σ) here relates to a potential function including long-range interactions and external interactions.

In an embodiment, the total rate defines a probability distribution and comprises a number of entities, wherein each entity defines one move of the object for which the rate is calculated from its current location to one unique other location in the reservoir or the continuous space.

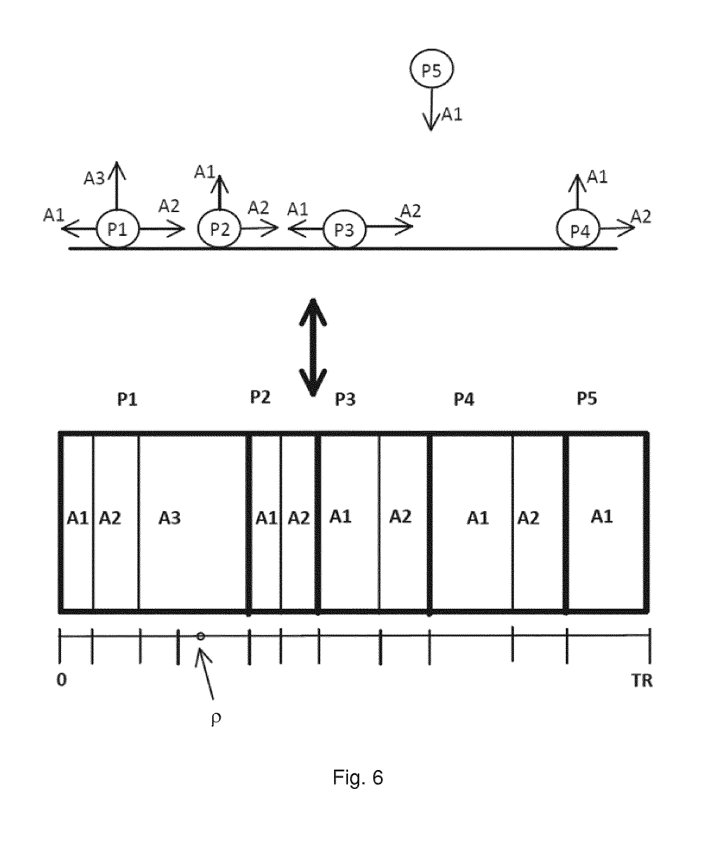

FIG. 6 illustrates a number of calculated total rates for each object P1, P2, P3, P4, P5 for a one-dimensional continuous space. The total rate of object P1 comprises the rates A1, A2, A3. The total rate of object P2, P3, and P4 each comprises two rates A1, A2, respectively. The total rate of object P5 comprises one rate A1. The total rates for each object define a region within the continuous space. Each region comprises at least one location to which an object for which the at least one rate is calculated can move to (see top part of FIG. 6). Each location within the region is associated with a coordinate (see bottom part of FIG. 6) of the rate to which the region comprising that location is associated. In FIG. 6 TR defines the set of calculated total rates. By randomly selecting a coordinate ρ within TR, the total rate to which the coordinate ρ belongs identifies the object to be moved. In this case, the randomly selected coordinate ρ is associated with the object P1, since the rate A3 comprises the randomly selected coordinate. Hence, this means that the object P1 will be moved to the location associated with the randomly selected coordinate.

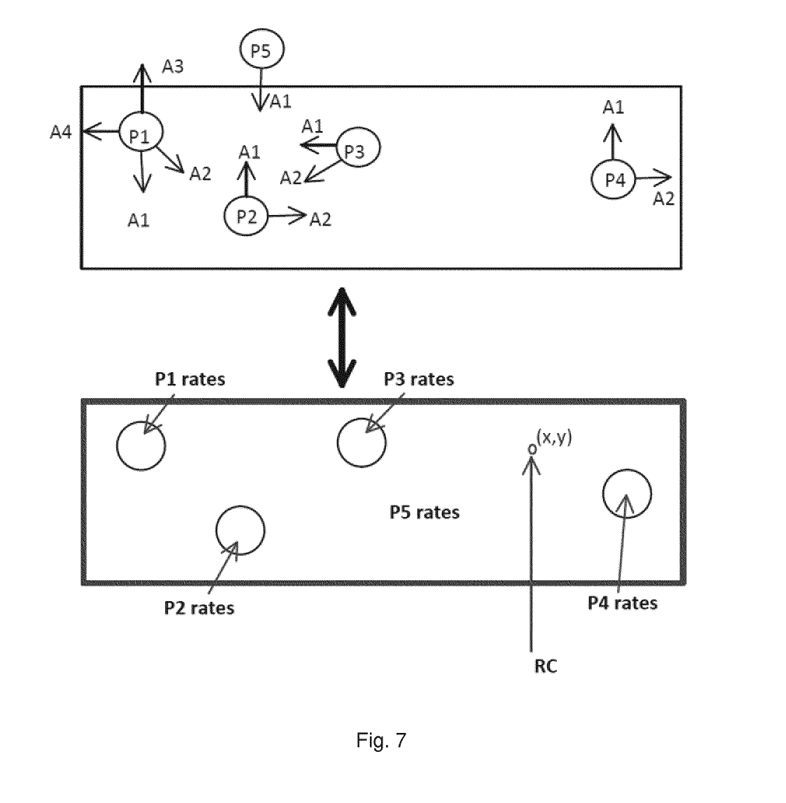

FIG. 7 illustrates a number of calculated total rates for each object P1, P2, P3, P4, P5 for a two-dimensional continuous space. The total rate of object P1 comprises four rates A1, A2, A3, A4. The total rate for object P2, P3, and P4 each comprises two rates A1, A2, respectively. The total rate of object P5 comprises one rate A1. The total rates for each object define a region within the continuous space. Each region comprises at least one location to which an object for which the at least one rate is calculated can move to (see top part of FIG. 7). Each location within the region is associated with a coordinate (x, y) (see bottom part of FIG. 7) of the rate to which the region comprising that location is associated. By randomly selecting a coordinate (x, y) within the set of calculated total rates, the total rate to which the coordinate (x, y) belongs identifies the object to be moved. In this case, the randomly selected coordinate (x, y) is associated with the object P5, since the rate A1 for P5 comprises the randomly selected coordinate. Hence, this means that the object P5 will be moved to the location (x,y) in the continuous space being associated with the randomly selected coordinate (x, y) from the set of calculated total rates.

Each of the first rates allows the respective object to move to different locations, and in different directions within the region defined by the first rate.

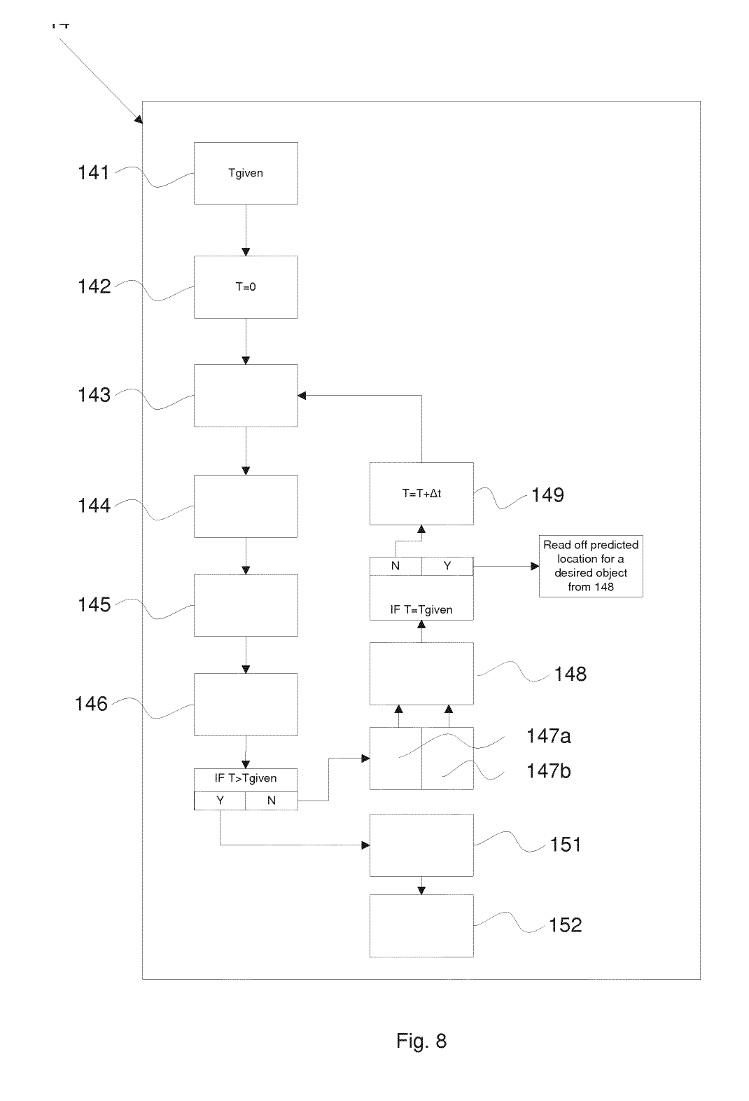

In an embodiment, according to FIG. 8, the unit 14 adapted to execute the Monte Carlo simulation is configured to access 141 a given end time (T_{given}) as input. The unit 14 is further configured to set 142 the time at the start of the simulation to zero (T=0). Furthermore, the unit 14 is configured to iteratively:

access 143 the indexed data;

access 144 the set of calculated total rates for the number of objects based on their respective current position;

randomly (145) select a coordinate within the set of calculated total rates,

identify (146) the rate to which the coordinate belongs, thereby identifying the object associated with the randomly selected coordinate;

wherein if the identified rate is a first rate of the total rate of the object, the unit (14) is adapted to:

move 147a the object corresponding to the randomly selected coordinate from its current location to the location associated with the randomly selected coordinate;

store 148 the new location for the moved object for each iteration in the memory 16,

update 149 the current simulation time T=T+Δt with a time step Δt related directly to the total value of the total rate of the object moved; and,

execute 150 steps 143 to 148 for each updated simulation time 149 as long as the updated simulation time is less or equal to the given end time.

In an embodiment, between each iteration step, the total rates for at least some of the objects are recalculated, whereby the unit 14 will access a set of calculated total rates which have been at least partly recalculated by the apparatus.

In an embodiment, the time step Δt is calculated as 1 divided by the total value of the total rate for the object being moved in step 147a.

In the event that the updated simulation time in step 149 exceeds the given end time (T_{given}), the unit 14 is configured to:

execute steps 143 to 146, wherein if the identified rate from step 146 is a first rate of the total rate of the object, the unit 14 is adapted to:

move 151 the object corresponding to the randomly selected coordinate to an intermediate location positioned between its current location and the unique other location corresponding to the randomly selected coordinate from step 146, wherein the distance between the current location and the intermediate location is calculated based on the distance between the current location and the location corresponding to the randomly selected coordinate times a ratio

$$( \frac{Tgiven - ( T - Δ t )}{Δ t} ) ,$$

defined by a subtraction between the given end time T_{given} and the preceding simulation T−Δt time divided by the updated time step Δt; and

store 152 the intermediate location for the moved object in the memory 16.

In an embodiment, wherein if the randomly selected coordinate belongs to a second rate of the total rates, which by definition is not a first rate, the unit 14 is adapted to:

move 147b the object from its current location to the reservoir; and,

store 148 the new location for the moved object for each iteration in the memory 16,

update 149 the current simulation time T=T+Δt with a time step Δt related directly to the total value of the total rate of the object moved; and,

execute 150 steps 143 to 148 for each updated simulation time 149 as long as the updated simulation time is less than or equal to the given end time.

In an embodiment, the time step Δt is calculated as 1 divided by the total value of the total rate for the object being moved in step 147b.

In an embodiment, wherein if the updated simulation time in step 149 exceeds the given end time T_{given}, the unit 14 adapted to execute the Monte Carlo simulation is configured to:

execute steps 143 to 146, and wherein if the identified rate from step 146 is a second rate of the total rates of the object, which per definition is not a first rate, the unit 14 is adapted to:

move 151 the object from its current location to the reservoir; and,

store 152 the new location for the moved object for each iteration in the memory 16.

In an embodiment the predicted location for an object at the given end time or for any intermediate time during the simulation is retrieved from the memory 16.

In an embodiment, the predicted location (x*), in the case of one-dimensional geometrical region, is given by:

x*=Δc*/cₐ+2r, where r is the radius for the object(s), cₐ is an adsorption constant, and Δc*=c*−Σᵢ₌₁^{m}c(i,σ), where c* is the randomly selected coordinate, and Σᵢ₌₁^{m}c(i,σ) defines the set of calculated total rates with m being the index of the total rate, being associated with the randomly selected coordinate, from the set of calculated total rates.

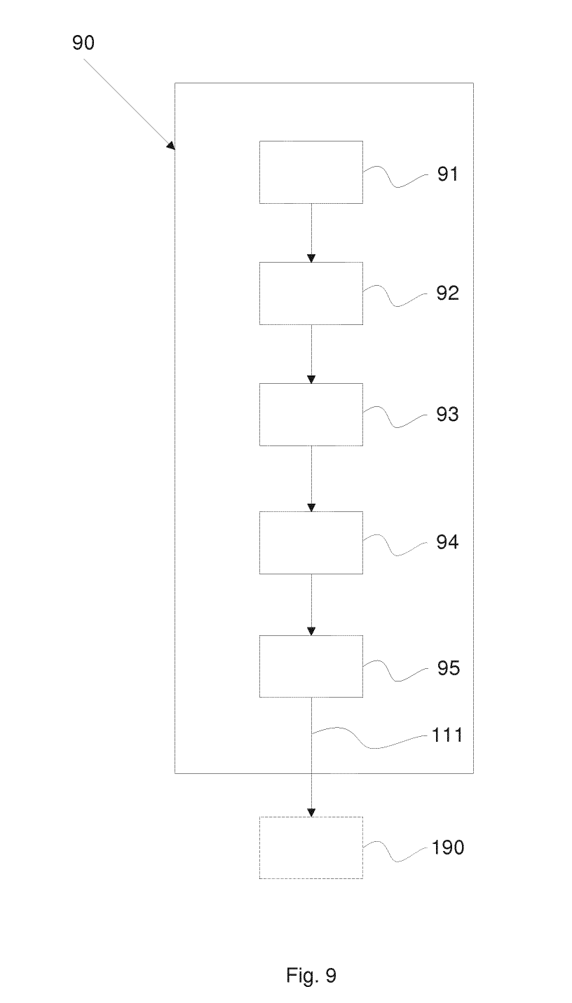

In an embodiment, according to FIG. 9 a method 90 for providing a control input signal 111 for an industrial process or technical system 190 having one or more controllable elements 131 is provided. The method comprises accessing 91 a dataset comprising data for a number of objects P1, P2, P3, P4, P5 being divided into a first set of objects and a second set of objects. The objects of the first set of objects are located in a reservoir. The second set of objects are being spatially distributed in a defined geometrical region at a fixed point in time. The geometrical region defines a continuous space including the locations of the second set of objects and locations of empty space to which the first set of objects and the second set of objects can move. The method further comprises indexing 92 the number of objects P1, P2, P3, P4, P5, resulting in indexed data. The method further comprises calculating 93 at least one rate R, c for each object P1, P2, P3, P4, P5 of the number of objects. The at least one rate defines a region within the continuous space, wherein the region comprises at least one location within the continuous space. Each at least one location is associated with a coordinate of the at least one rate. At least a first rate of the at least one calculated rate for each object is calculated with a weight corresponding to the amount of empty space available between the second set of objects P1, P2, P3, P4, P5 within the continuous space. The number of rates calculated for each object is added to form a total rate for each object. The total rates for the number of objects form a set of calculated total rates. Furthermore, the method comprises executing 94 a Monte Carlo simulation based on the indexed data and the set of calculated total rates and to calculate a predicted location for an object of the number of objects at a given end time, wherein the predicted location is either within the continuous space or within the reservoir. Moreover, the method comprises providing 95 the predicted location for at least one object P1, P2, P3, P4, P5 in a control input signal to said industrial process or technical system 190.

In an embodiment, the method 90 comprises steps for performing the tasks performed by the apparatus according to any embodiment disclosed herein.

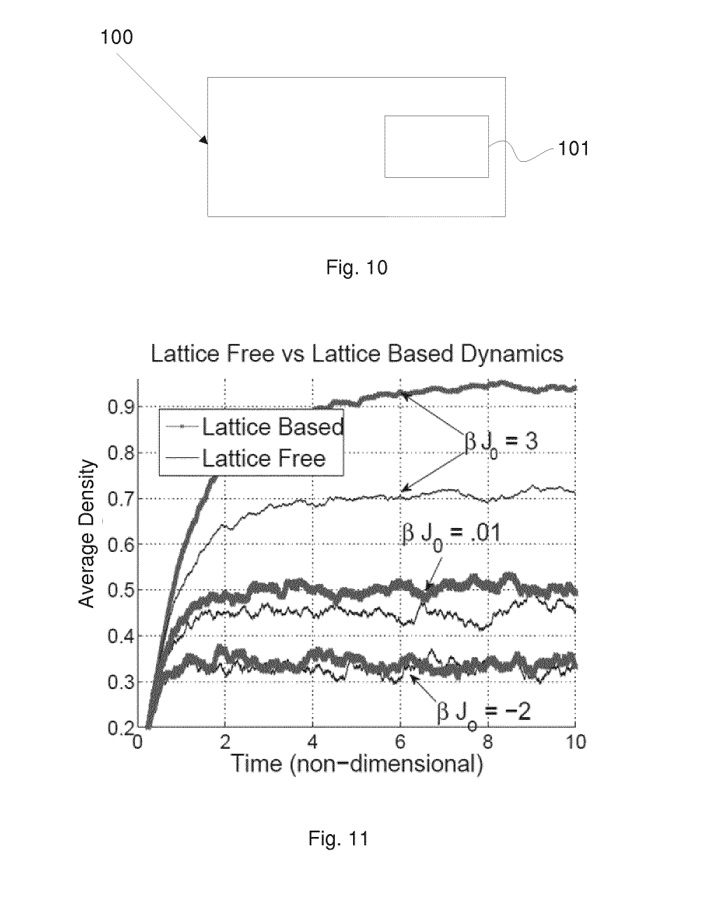

In an embodiment, according to FIG. 10, a computer-readable medium 100 is provided. The computer-readable medium comprises code segments 101 arranged, when run by an apparatus having computer-processing properties, for performing all of the steps of the method according to any embodiment disclosed herein.

In an embodiment, according to FIG. 13, a technical system 190 comprising one or more controllable elements 131 is provided. At least one of the controllable elements is configured to receive the control input signal 111 from the apparatus 10 according to any of the embodiments disclosed herein.

In an embodiment, according to FIG. 14, a system 200 comprising the technical system 190 and apparatus according 10 to any one of the embodiments disclosed herein is provided.

Applicability

In an embodiment, the industrial process or the technical system is a traffic control system, wherein the geometrical region defines at least one roadway and the objects are vehicles moving along the roadway. In this embodiment, one-sided potentials are used. In this respect the interaction function V specified earlier is defined as follows: V(s)=J₀ for 0<s<1 and V(s)=0 otherwise. Here, one or more of the calculated rates for an object is a spin-flip rate allowing the vehicles to enter or exit the roadway. Moreover, one or more rates of the calculated rates for an object may be a spin-exchange rate allowing the vehicles to move forward, sideways or turn in the roadway. Furthermore, one or more of the calculated rates for an object may be calculated based on an interaction potential including external interactions to impose limitations from traffic lights, weather conditions, accidents at specific locations, or time intervals.

When the continuous space relates to a roadway or roadway system the predicted location for one or more objects at a given time may be used by the industrial process or technical system to control the roadway lights such as to avoid any unnecessary traffic jam, in intersections along the roadway.

It is important that the traffic flow along a roadway or roadway system must be maintained at as high capacity as possible, allowing for as high throughput as possible in terms of the number of vehicles passing a specific location. By means of the control input signal traffic lights at entrances in the roadway may be instructed to limit the number of new vehicles entering the roadway in an effort to avoid the future traffic jam. The control input signal may also control the amount of time that the traffic light will remain red or green. The control input signal may be continuously updated or updated at regular intervals such as to allow for an optimal capacity for the roadway given the current traffic. The control input signal may also be used by the technical process or technical system to send a signal to e.g. a mobile phone or any other mobile device used by drivers along the roadway or to a stationary device warning drivers using the roadway of upcoming exit routes which are shown in the simulation to provide better alternatives will less congestion.

In an embodiment, the objects are neutrons interacting in a semi-conductor constituting the geometrical region.

In an embodiment, the objects are chemical reactants located at a surface of a reactor constituting the geometrical region, wherein the chemical reactants are able to interact with each other and with the reactor's gas phase, and wherein one or more of the at least one rate is a spin-flip rate, spin exchange rate, or contact rate.

In an embodiment, the objects are plants, animals, or humans interacting with each other within a geographical region constituting the geometrical region, wherein one or more of the calculated rates is calculated based on an interaction potential relating to a contact or transport process for spreading of a disease.

In an embodiment, the objects are fluid molecules, air molecular or larger parcels, and wherein the calculated rate for each object is a spin-exchange rate or spin-flip rate, defining the movement of the objects through their geometrical region.

In an embodiment, the objects are granules of different sizes, which granules are allowed to mix to form a substance, wherein the rates calculated for each granule is dependent on the individual object size for each granule.

Experimental Data

In the example simulations below comparative results are presented for both the commonly known lattice based (LB) approach and the lattice free (LF) approach of the present invention. The results are based on processing objects interacting under the influence of spin-flip dynamics using Monte Carlo simulations in one-dimension. Circular boundary conditions apply. Other types of boundary conditions can easily be implemented as well without difficulty. Simulations for higher dimensions will be carried out in the future. A comparison between the commonly known lattice based approach and the lattice free approach of the present invention is shown in FIG. 11. Three examples are presented in FIG. 11 based on different choices of the temperature parameter βJ₀=−2,0.01,3 for repulsive, (almost) neutral and attractive dynamics respectively. It is known in the art that for βJ₀=−2,0.01,3 the average density for LB dynamics should be approximately 0.34,0,0.94 respectively. The dynamics are compared pathwise and at equilibration. The case of βJ₀=−2 does not show any obvious discrepancy. Any positive temperature however βJ₀>0 will involve significant errors in average density if LB dynamics are used as compared to the average density defined by the Palasti conjecture. The case βJ₀=3, for instance, promoting high object densities, produces significantly different dynamics.

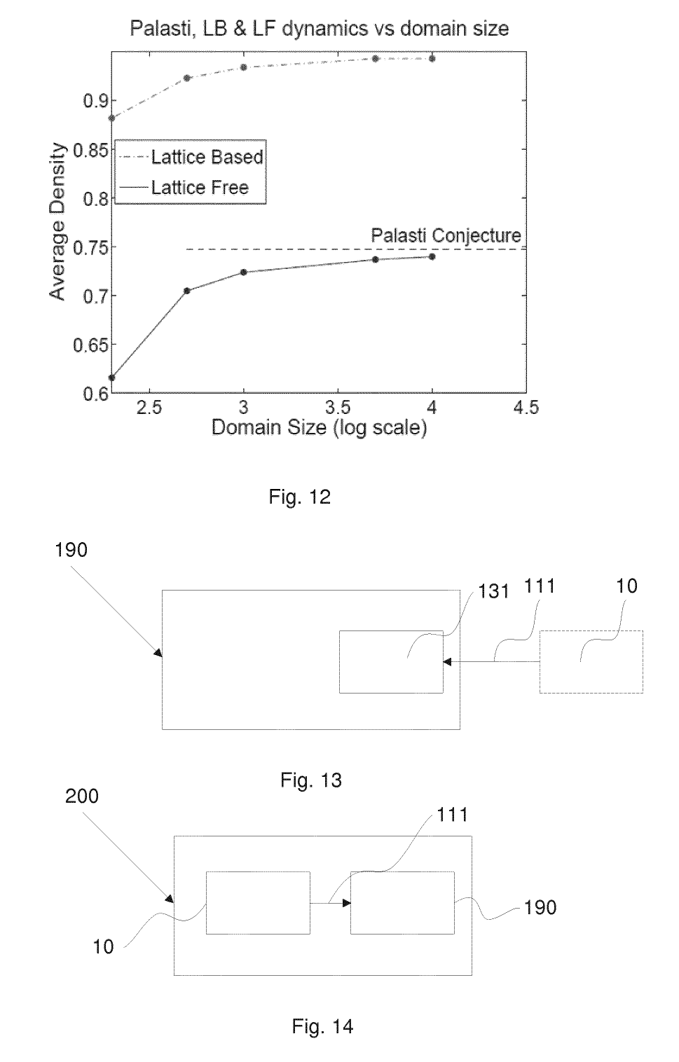

FIG. 12 illustrates a comparison of total average density for βJ₀=3 versus domain size for the classic LB dynamics versus the LF dynamics of the present invention. Each point corresponds to ensemble, uncorrelated, density averages c̅ after equilibration. As may be observed from FIG. 12 the LF dynamics produce the correct result according to the Palasti conjecture.

The results from FIG. 12 and especially in Table 1 below show disagreement between LB and LF dynamics for all values of βJ₀=3. The difference in solutions is quite significant for the case of βJ₀=3. The case of βJ₀=3 corresponds to high object densities. In fact, as presented in the more detailed study in Table 1, all temperatures βJ₀>0 would fall into that category with increasing discrepancies for higher object densities and corresponding increasingly higher differences in the dynamics. In Table 2 further long-time ensemble averages are calculated for the case βJ₀=3 in order to better understand this discrepancy between LB and LF dynamics as domain size increases.

Table 1 illustrates the average density

$$c = \frac{⊥}{k + l} Σσ ( x )$$

in one-dimension for a range of βJ₀ values. Averages are provided over several uncorrelated ensembles. It should be appreciated that the LB density is clearly different than that in the LF dynamics. The errors increase as temperature βJ₀ (and object density) increases.

TABLE 1

| βJ₀ | −10 | −3 | −2 | −1 | 0 | 1 | 2 | 3 | 10 |
|---|---|---|---|---|---|---|---|---|---|
| Density | .189 | .295 | .336 | .486 | .504 | .663 | .835 | .945 | .997 |
| (LB) | | | | | | | | | |
| Density | .174 | .287 | .325 | .439 | .449 | .549 | .649 | .743 | .744 |
| (LF) | | | | | | | | | |
| Rel. | 3 | 3 | 3 | 9 | 11 | 17 | 22 | 22 | >22 |
| Errors | | | | | | | | | |
| (%) | | | | | | | | | |

Table 2 illustrates the average density

$$c = \frac{⊥}{k + l} Σσ ( x )$$

in one-dimension for βJ₀=3 as domain size increases. Averages over several ensembles. Results shown in FIG. 4. The LB density is clearly different than the LF dynamics regardless of domain size. Convergence will not fix that difference. The theoretical estimate (6.1) for domain size N→∞ is c=0.94959 which supports the LF solution.

TABLE 2

| Domain Size | 200 | 500 | 1000 | 5000 | 10000 | 20000 |
|---|---|---|---|---|---|---|
| Density(LB) | .882 | .923 | .934 | .941 | .942 | .945 |
| Density(LF) | .616 | .705 | .724 | .736 | .740 | .743 |

Comparison Between the LF Dynamics to the Theoretical Estimate

A theoretical known result from Renyi as well as the well-known conjecture due to Palasti further validate our findings since it is shown in the art that as the line becomes infinite in length the packing density c* of randomly placed unit intervals is

$${c}_{*} = {\int }_{0}^{∞} exp \{ - 2 {\int }_{0}^{t} \frac{1 - {e}^{- u}}{u} d u \} d t = .74759 . \qquad ( 6.1 )$$

This theoretical value is in agreement with the numerical solutions obtained in FIG. 12 for βJ₀=3 as well as the extended results shown in Table 2. It is clear from Table 2 that for the full range of temperatures −10≦βJ₀≦10 we have obtained a similar upper bound which agrees with this conjecture. The Palasti conjecture further states that in n-dimensions the random packing density of unit squares would be cⁿ*.

Based on the simulated experimental data it has been shown that the dynamics are clearly different between LB and LF processes, as may be observed from FIG. 12. The present inventor has found that if commonly known LB dynamics are used to model physical processes which evolve continuously in space then erroneous solutions can result for all values of βJ₀. These errors become larger with increasing βJ₀ as shown by the relative errors in Table 1. In this case statistical estimates of densities from LB dynamics are always greater (and wrong) than those of LF dynamics of the present invention. The relative errors presented in Table 1 become significant as soon as βJ₀>0. Furthermore, as has been shown in FIG. 12, increasing the lattice size and/or number of interacting objects will not diminish these errors.

Hence, the present inventor has found some of the issues resulting due to the fact that for a number of models object size is actually important towards understanding system behavior. Accordingly, in many physical applications significant errors can occur if one disregards the effects due to object size. So the errors for lattice-based dynamics are significant both in terms of predicting wrong average densities but also in terms of predicting individual object behavior, as objects will behave differently if the densities around them are higher than they should be.

The significant errors give rise to a problem because in many instances objects modeled with commonly known lattice based dynamics actually have significant (non-negligible) size in relation to their domain and therefore it is not physically meaningful to take the limit as the lattice cell gets smaller and smaller.

The realization made by present inventor have direct consequences in the modeling of a number of physical applications for which LB models have been used inappropriately (i.e for modeling objects of non-negligible size). A large amount of work in CA simulations for instance comes into question due to the fact that LB dynamics seem to produce wrong solutions at high concentrations. A CA simulation of traffic flow for instance is the predominant methodology of solutions especially during high vehicle concentrations. Accordingly, such simulations should not be trusted for the simple reason that actual vehicles do not move in lattice cells (even if safe distances are included). Similar such examples exist in many other fields where LB dynamics have been applied to model continuous spatial interactions at high densities. In such cases therefore LB dynamics should not be applied. In particular, the size of the lattice cannot and should not be considered as cell size goes to 0 if object sizes are important towards understanding the behavior of the actual physical system we try to model. Hence, as the LF process of the present invention does not result in any significant errors it allows for an improved way of predicting locations for objects by means of the continuous space.

It should be noted that although the continuous space is not a lattice the adsorption rates based on equation 3.1 will always be countable. Hence, the calculation of the adsorption rate for each object is not just an abstract mathematical object but can also be constructed as shown in the pseudo-code provided below. This pseudo-code gives only a rough outline of the main algorithm.

Pseudo-code for lattice-free Monte Carlo dynamics
The pseudo-code for Arrhenius spin-flip dynamics according to an
embodiment using a one-dimensional continuous space is provided below.

```
    1. Calculate a first rate relating to adsorption c^{a}(l) and a second rate
related to desorption c^{d}(l) from (3.1) for each object in the continuous
space [symbol]
    2. Calculate a total rate for each object to adsorb Rₐ = Σₗc^{a}(l) or
    desorb
R_{d} = Σₗc^{d}(l) by adding the first rate and second rate for each object,
resulting in a total rate R=Rₐ+R_{d}.
    3. Obtain a random coordinateρ. Index rates in an array c.
    4. Find j and x* for which Σⱼ₌₀^{m}c(j) ≧ ρR > Σⱼ₌₀^{m-1}c(j)
    5. Update the time, t=t+Δt where Δt=1/R.
    6. Repeat until a predicted location for the object of the last iteration
at a given end time has been obtained..
```

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The foregoing has described the principles, preferred embodiments and modes of operation of the present invention. However, the invention should be regarded as illustrative rather than restrictive, and not as being limited to the particular embodiments discussed above. The different features of the various embodiments of the invention can be combined in other combinations than those explicitly described. It should therefore be appreciated that variations may be made in those embodiments by those skilled in the art without departing from the scope of the present invention as defined by the appended claims.

1. A method for providing a control input signal for a traffic control system having one or more controllable elements, the method comprising:
accessing a dataset comprising data for a number of vehicles (being divided into a first set of vehicles and a second set of vehicles, wherein the vehicles of the first set of vehicles are located in a reservoir, and the vehicles of the second set of vehicles are being spatially distributed in a defined geometrical region, defining at least one roadway, at a fixed point in time, wherein said geometrical region defines a continuous space including the locations of the second set of vehicles and locations of empty space to which the first set of vehicles and the second set of vehicles can move;
indexing the number of vehicles, resulting in indexed data;
calculating at least one rate for each vehicle of the number of vehicles, said at least one rate defining a region within the continuous space, said region comprising at least one location within the continuous space, wherein each at least one location is associated with a coordinate of the at least one rate, wherein at least a first rate of the at least one calculated rate for each vehicle is calculated with a weight corresponding to the amount of empty space available between the second set of vehicles within the continuous space, wherein the number of rates calculated for each vehicle is added to form a total rate for each vehicle, and wherein the total rates for the number of vehicles form a set of calculated total rates;
executing a Monte Carlo simulation based on the indexed data and the set of calculated total rates and to calculate a predicted location for a vehicle of the number of vehicles at a given end time, wherein the predicted location is either within the continuous space or within the reservoir; and
providing the predicted location for at least one vehicle in the control input signal to said traffic control system.

2. The method of claim 1, wherein one or more of the first rates is a spin-flip rate related to adsorption or a deposition rate.

3. The apparatus method according to claim 1, wherein a second rate of the at least one rate calculated for each vehicle is a spin flip rate related to desorption.

4. The method according to claim 2, wherein the act of calculating at least one rate for each vehicle of the number of vehicles comprises:
identifying an empty space within the continuous space between two or more vehicles of the number of vehicles;
measuring the size of each identified empty space, and categorizing each identified empty space which is large enough to accommodate a vehicle in a first set of empty space; and
based on the identified first set of empty space, calculating the first rate for a vehicle in the first set of vehicles allowing for that vehicle of the first set of vehicles to land at each empty space of the first set of empty space.

5. The method according to claim 1, wherein one or more of the first rates is a spin-exchange rate related to diffusion.

6. The method according to claim 5, wherein the act of calculating at least one rate for each vehicle of the number of vehicles comprises:
identifying an empty space within the continuous space between a vehicle of the second set of vehicles, for which vehicle the first rate is to be calculated, and at least one other vehicle in the second set of vehicles;
calculating an interaction potential for each vehicle of the second set of vehicles to move to the empty space identified for that vehicle, said interaction potential defining a set of functions related to how the vehicle is allowed to interact with the other vehicles in the data; and,
based on the interaction potential calculating the first rate for each vehicle in the second set of vehicles, wherein each first rate allows for a vehicle to land at the empty space identified for that vehicle.

7. The method according to claim 6, wherein the interaction potential, J, is calculated by the formula
$$J ( i - j ) = \frac{1}{{( 2 L + 1 )}^{d}} V ( \frac{1}{2 L + 1} \vert {\vec{x}}_{i} - {\vec{x}}_{j} \vert ) , 1 \leq i \leq k + l ,$$
wherein V is a potential function, L is the interaction radius, d is the dimension of the continuous space, |\vec{x}ᵢ−\vec{x}ⱼ| is the distance between two locations i and j, k defines the number of vehicles, and l defines the number of available empty spaces.

8. The method according to claim 1, wherein each calculated rate is a deterministic rate being defined by functions which include a set of variables and parameters, wherein each variable is an unknown which may take any value within a predefined range.

9. The method according to claim 1, wherein a second rate of the at least one rate for each vehicle is a contact rate.

10. The method according to claim 6, wherein said at least one interaction potential defines interactions being related to:
anisotropy;
local interactions of each object vehicle with other vehicles on a look-ahead or symmetric basis;
long-range interactions; or
external interactions.

11. The method according to claim 10, wherein the act of executing the Monte Carlo simulation comprises:
accessing a given end time as input;
setting the time at the start of the simulation to zero;
and iteratively:
accessing (143) the indexed data;
accessing (144) the set of calculated total rates for the number of vehicles based on their respective current position;
randomly (145) selecting a coordinate within the set of calculated total rates;
identifying (146) the rate to which the coordinate belongs, thereby identifying the vehicle associated with the randomly selected coordinate;
wherein if the identified rate is a first rate of the total rate of the vehicle, the act of executing the Monte Carlo simulation further comprises:
moving (147a) the vehicle corresponding to the randomly selected coordinate from its current location to the location associated with the randomly selected coordinate; and
storing (148) the new location for the moved vehicle for each iteration;
updating the current simulation time with a time step related directly to the total value of the total rate for the vehicle moved; and
executing steps (143) to (148) for each updated simulation time as long as the updated simulation time is less than or equal to the given end time.

12. The method of claim 11, wherein if the updated simulation time exceeds the given end time, the act of executing the Monte Carlo simulation further comprises:
executing steps (143) to (146), wherein if the identified rate from step (146) is a first rate of the total rate of the vehicle, the act of executing the Monte Carlo simulation further comprises:
moving the vehicle corresponding to the randomly selected coordinate to an intermediate location positioned between its current location and the unique other location corresponding to the randomly selected coordinate from step (146), wherein the distance between the current location and the intermediate location is calculated based on the distance between the current location and the location corresponding to the randomly selected coordinate times a ratio
$$( \frac{Tgiven - ( T - Δ t )}{Δ t} )$$
defined by a subtraction between the given end time, T_{given}, and the preceding simulation time, T−Δt, divided by the updated time step, Δt; and
storing the intermediate location for the moved vehicle.

13. The method according to claim 11, wherein if the randomly selected coordinate belongs to a second rate of the total rates, which is not a first rate, the act of executing the Monte Carlo simulation comprises:
moving (147b) the vehicle from its current location to the reservoir; and
storing (148) the new location for the moved vehicle for each iteration,
updating the current simulation time with a time step related directly to the total value of the total rate of the vehicle moved; and
executing steps (143) to (148) for each updated simulation time as long as the updated simulation time is less than or equal to the given end time.

14. The method of claim 11, wherein if the updated simulation time exceeds the given end time, the act of executing the Monte Carlo simulation further comprises:
executing steps (143) to (146), and wherein if the identified rate is a second rate of the total rates of the vehicle, which is not a first rate, the act of executing the Monte Carlo simulation further comprises:
moving the vehicle from its current location to the reservoir; and
storing the new location for the moved vehicle for each iteration.

15. (canceled)

16. The method according to claim 1, wherein the predicted location, x*, in the case of one-dimensional geometrical region, is given by:
$${x}^{*} = \frac{Δ {c}^{*}}{{c}_{α}} + 2 r ,$$
where r is the radius for the vehicle(s), ca is an adsorption constant, and Δc*=c*−Σᵢ₌₁^{m}c(i,σ), where c* is the randomly selected total rate, and Σᵢ₌₁^{m}c(i,σ) defines the defines the set of calculated total rates with m being the index of the total rate being associated with the randomly selected coordinate, from the set of calculated total rates.

17. The method according to claim 1, wherein one or more of the calculated rates for a vehicle is a spin-flip rate allowing the vehicles to enter or exit a roadway.

18. The method according to claim 1, wherein one or more rates of the calculated rates for a vehicle is a spin-exchange rate allowing the vehicle to move forward, sideways or turn in the roadway.

19. The method according to claim 1, wherein one or more of the calculated rates for a vehicle is calculated based on an interaction potential including external interactions to impose limitations from traffic lights, weather conditions, accidents at specific locations, or time intervals.

20. The method according to claim 1, wherein the Monte Carlo simulation is a kinetic Monte Carlo simulation.

21. An apparatus for providing a control input signal for a traffic control system having one or more controllable elements, the apparatus comprising:
a unit adapted to access a dataset comprising data for a number of vehicles being divided into a first set of vehicles and a second set of vehicles, wherein the first set of vehicles are located in a reservoir, and the second set of vehicles are being spatially distributed in a defined geometrical region, defining at least one roadway, at a fixed point in time, wherein said geometrical region defines a continuous space including the locations of the second set of vehicles and locations of empty space to which the first set of vehicles and the second set of vehicles can move;
a unit adapted to index the number of vehicles, resulting in indexed data;
a unit adapted to calculate at least one rate for each vehicle of the number of vehicles, said at least one rate defining a region within the continuous space, said region comprising at least one location within the continuous space, wherein each at least one location is associated with a coordinate of the at least one rate, wherein at least a first rate of the at least one calculated rate for each vehicle is calculated with a weight corresponding to the amount of empty space available between the second set of vehicles within the continuous space, wherein the number of rates calculated for each vehicle is added to form a total rate for each vehicle, and wherein the total rates for the number of vehicles form a set of calculated total rates;
a unit adapted to execute a Monte Carlo simulation based on the indexed data and the set of calculated total rates and to calculate a predicted location for a vehicle of the number of vehicles at a given end time, wherein the predicted location is either within the continuous space or within the reservoir; and wherein the predicted location is stored on a memory operatively coupled to the apparatus; and
a unit adapted to provide the predicted location for at least one vehicle in the control input signal to said traffic control system.

22. (canceled)

23. A computer-readable medium, comprising code segments arranged, when run by an apparatus having computer-processing properties, for performing the method of claim 1.

24. A system comprising a traffic control system and the apparatus according to claim 1.
